(19) United States
(12) Patent Application Publication
(10) Pub. No.: US 2024/0272872 A1
(43) Pub. Date: Aug. 15, 2024

(54) COMPUTING SYSTEM

(71) Applicant: Nippon Telegraph and Telephone Corporation, Tokyo (JP)

(72) Inventors: Tsuyoshi Ito, Tokyo (JP); Yuki Arikawa, Tokyo (JP); Tsutomu Takeya, Tokyo (JP); Kenji Tanaka, Tokyo (JP)

(21) Appl. No.: 18/569,383

(22) PCT Filed: Jun. 21, 2021
(86) PCT No.: PCT/JP2021/023377

§ 371 Date: Dec. 12, 2023

(51) Int. Cl. G06F 7/57

(52) U.S. Cl. CPC G06F 7/57

(57) ABSTRACT

A computing system includes a first computer for writing an arithmetic circuit in a reconfigurable first region included in a first accelerator and a second computer for writing the arithmetic circuit in a reconfigurable second region included in a second accelerator different from the first accelerator and having the same circuit arrangement as the first region. When the first computer writes a new arithmetic circuit in the first region, the second computer writes the new arithmetic circuit in a partial region of the second region at the same position as the unwritten partial region of the first region. The first computer does not write the new arithmetic circuit in the first region when the new arithmetic circuit is not normally written, and writes the new arithmetic circuit in the unwritten partial region of the first region when the new arithmetic circuit is normally written.

### CROSS-REFERENCE TO RELATED APPLICATIONS

This application is a national phase entry of PCT Application No. PCT/JP2021/023377, filed on Jun. 21, 2021, which application is hereby incorporated herein by reference.

### TECHNICAL FIELD

The present invention relates to a computing system.

### BACKGROUND

In recent years, a part of processing performed by a computer is executed not by a CPU but by an accelerator capable of reconfiguring a circuit and processing speed is reduced, thus techniques for realizing virtual reality or artificial intelligence on the Internet have been developed. In PTL 1 disclosing such techniques, a technique for appropriately rewriting a circuit written in an FPGA accelerator of a computer in accordance with processing executed by the FPGA accelerator is disclosed.

### CITATION LIST

### Patent Literature

PTL 1—Japanese Patent Application Publication No. 2018-206195.

### SUMMARY

### Technical Problem

In the technique described in the above PTL 1, since a new arithmetic circuit is directly written into the FPGA accelerator, if the new arithmetic circuit is not normally written into the FPGA accelerator, an inconvenience in which the FPGA accelerator does not operate normally may occur.

An object of embodiments of the present invention is to make it difficult to cause such inconvenience that an accelerator of a writing destination does not operate normally when an arithmetic circuit is written.

### Solution to Problem

In order to solve the above problem, a computing system according to embodiments of the present invention includes a first computer configured to write an arithmetic circuit in a reconfigurable first region included in a first accelerator and a second computer configured to write the arithmetic circuit in a reconfigurable second region having the same circuit arrangement as the first region included in a second accelerator different from the first accelerator, wherein the second computer is configured to write a new arithmetic circuit in a partial region of the second region at the same position as an unwritten partial region of the first region when the first computer writes the new arithmetic circuit in the first region, and the first computer does not write the new arithmetic circuit to the first region when the new arithmetic circuit is not normally written, and writes the new arithmetic circuit to the unwritten partial region of the first region when the new arithmetic circuit is normally written.

### Advantageous Effects of Embodiments of Invention

According to embodiments of the present invention, it is possible to make it difficult to cause such inconvenience that the accelerator of the writing destination does not operate normally when the arithmetic circuit is written.

### BRIEF DESCRIPTION OF THE DRAWINGS

FIG. 1 is a hardware configuration diagram of a computing system according to an embodiment of the present invention.

FIG. 2 is a configuration diagram of a first accelerator and a second accelerator.

FIG. 3 is a flowchart showing an accelerator control management processing.

FIG. 4 is a configuration diagram of the first accelerator and the second accelerator.

FIG. 5 is a configuration diagram of the first accelerator and the second accelerator.

FIG. 6 is a flowchart of writing processing.

FIG. 7 is a configuration diagram showing how to change a writing region of a second region of the second accelerator.

FIG. 8 is a hardware configuration diagram of a computing system according to a modification example of FIG. 1.

### DETAILED DESCRIPTION OF ILLUSTRATIVE EMBODIMENTS

A computing system 10 and the like according to an embodiment of the present invention will be described below with reference to the drawings.

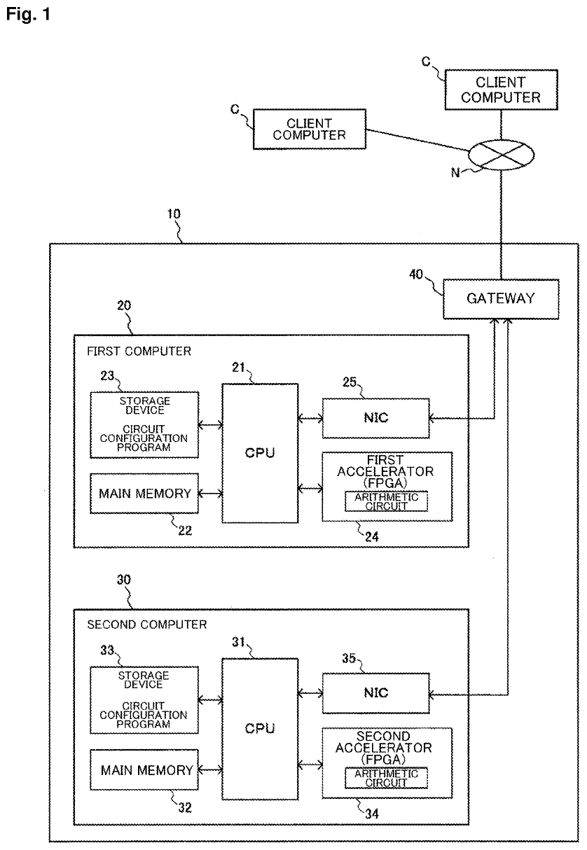

As shown in FIG. 1, a computing system 10 includes a first computer 20, a second computer 30, a gateway 40 as a third computer communicably connected to the computers 20 and 30 via a LAN (Local Area Network) or the like (not shown). The gateway 40 is connected to a network N such as the Internet. The gateway 40 relays data, in this case, images and the like, exchanged between the computers 20 and 30 and client computers C of users using the computing system 10 connected to the network N.

The computers 20 to 40 operate as nodes of a computer network for performing various types of processing in response to requests from each of the plurality of client computers C. Here, each client computer C transmits an image to the computing system 10 and requests image processing for the image. The computing system 10 performs image processing on the transmitted image, and returns the image after the image processing to the client computer C of the transmission source of the image. As will be described later, the image processing is mainly performed by the first computer 20.

The first computer 20 includes a CPU (Central Processing Unit) 21, a RAM 22 such as a DRAM (Dynamic Random Access Memory) functioning as a main memory of the CPU 21, and a nonvolatile storage device 23. The first computer 20 further includes a first accelerator 24 constituted of an FPGA (Field Programmable Gate Array) and a NIC (Network Interface Card) 25 which is a network card. The storage device 23 is an auxiliary storage device such as a hard disk or an SSD (Solid State Drive). When the CPU 21 exchanges data with a gateway or the like outside the first computer 20, the exchange is performed via the NIC 25. The CPU 21 executes a program stored in the storage device 23 and read out to the RAM 22 to perform processing to be described later.

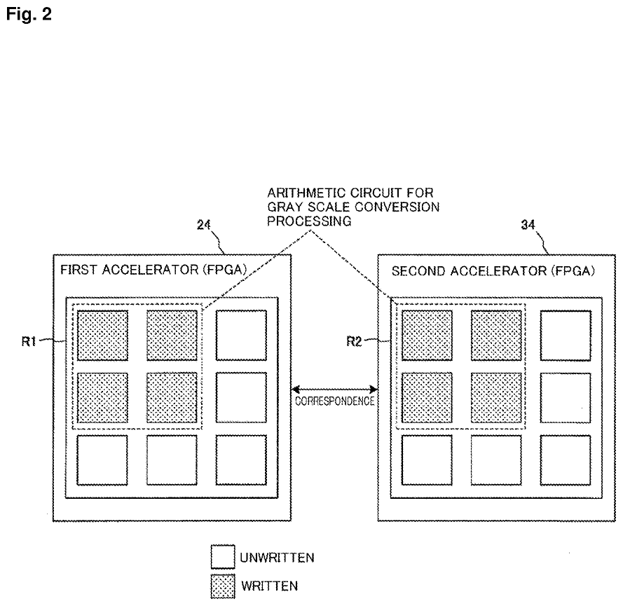

The second computer 30 is constituted by the same computer as the first computer 20 (different from the program or the like). As shown in FIG. 2, the second computer 30 includes a CPU 31, a RAM 32, a storage device 33, a second accelerator 34, and a NIC 35.

As each of the computers 20 and 30, for example, a SYS-4028GR-TR2 server manufactured by Super Micro Computer Inc. is adopted. On a CPU mother board of the server, two sets of E5-2600V4 of Xeon (Registered Trademark) CPU processors manufactured by Intel Corp. are mounted as CPUs, and eight pieces of memory cards of DDR4-2400 DIMM 32 GB manufactured by I-O Data Device Inc. are mounted as RAMs. Further, a daughter board of 16 lane slots of PCI Express 3.0 (Gen3) is mounted on the CPU mother board, one ALVEO U250 manufactured by Xillinx Inc. is mounted on the slot as an accelerator, as the NIC, one piece of ConnectX-4 VPI MCX455A-ECAT manufactured by Mellanox Technologies Ltd. is mounted.

In the first computer 20, a plurality of types of image processing is executed. A part of the plurality of types of executable image processing is performed by executing the image processing program stored in the storage device 23 by the CPU 21. The rest of the plurality of types of image processing executable by the first computer 20 is written in a reconfigurable first region of the first accelerator 24, and is executed by an arithmetic circuit configured in the first region. The arithmetic circuit is written in the first region by applying a circuit configuration (bit stream file) representing the arithmetic circuit stored in the storage device 23 to a part of the first region by the CPU 21.

Here, it is assumed that one of image processing performed by the CPU 21 executing the image processing program stored in the storage device 23 is pixel sorting processing for sorting each pixel of the image. Further, the image processing executed by the arithmetic circuit is a gray scale conversion processing for converting an image after pixel sorting into a gray scale image.

The second accelerator 34 of the second computer 30 has a reconfigurable second region of the same circuit arrangement (switch cell, LUT (Look Up Table), and wiring are the same arrangement) as the first region of the first accelerator 24. The same arithmetic circuit is written in the second region at the same position as the first accelerator 24. More specifically, the storage device 33 stores a circuit configuration similar to that of the first computer 20. The CPU 21 of the first computer 20 notifies the gateway 40 of the type of the arithmetic circuit written in the first accelerator 24 and the writing position in the first region. The gateway 40 notifies the second computer 30 of the type and writing position of the arithmetic circuit notified from the first computer 20. The CPU 31 of the second computer 30 applies the same circuit configuration to the second region of the second accelerator 34 on the basis of the notification, and writes the same arithmetic circuit in the same position. In this way, the arithmetic circuits reconfigured in the first region and the second region are the same. Note that, as will be described later, when the same arithmetic circuit has already been written in the same position in the second accelerator 34, the arithmetic circuit is not written in the second computer 30.

It is assumed that a plurality of types of circuit configurations is registered in the storage devices 33 and 43, and a circuit configuration representing an arithmetic circuit for executing gray scale conversion processing as one of them is applied to the respective accelerators 24 and 34. The circuit configurations registered in the storage devices 33 and 43 are also registered in the gateway 40. That is, the gateway 40 grasps the types of arithmetic circuits that can be written into the respective accelerators 24 and 34. Further, the gateway 40 grasps a written region and an unwritten region of the regions R1 and R2 on the basis of the notification from the CPU 21 of the first computer 20.

Here, as shown in FIG. 2, it is assumed that each of the first region R1 and the second region R2 of each of the accelerators 24 and 34 has nine blocks of 3×3. Then, in each of the first region R1 and the second region R2, an arithmetic circuit for executing the gray scale conversion processing by using four blocks on the upper left side is written. That is, in FIG. 2, the arithmetic circuit has already been written in blocks to which dots are attached, and the arithmetic circuit has not been written in white blocks.

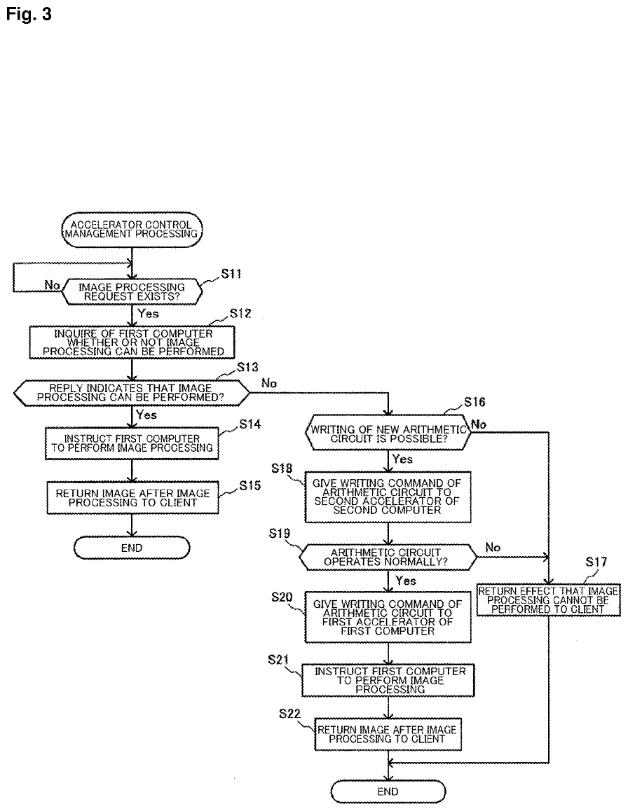

The gateway 40 is constituted of a server computer or the like, and includes a CPU, a main memory, a nonvolatile storage device, and an NIC (not shown). The gateway 40 executes the accelerator control management processing shown in FIG. 3.

In the processing shown in FIG. 3, the gateway 40 first waits until an image processing request including an image and designation information designating the type of image processing for processing the image is received from any of the plurality of client computers C (step S11). When the reception is present, the gateway 40 inquires of the first computer 20 whether or not the image processing of the type designated by the designation information can be performed (step S12). The first computer 20 discriminates whether or not the image processing that has received the inquiry can be performed. When the designation information of the image processing request is pixel sorting processing and gray scale processing, the CPU 21 of the first computer 20 discriminates that the image processing of the image processing request can be performed, and returns the effect to the gateway 40.

When there is a reply indicating that the image processing of the image processing request can be performed (step S13; Yes), the gateway 40 supplies the image included in the image processing request to the first computer 20, and instructs execution of the image processing of which it can be performed in the reply (step S14). In this case, the CPU 21 performs the pixel sorting to the received image by executing a program, and performs the gray scale conversion to the image after sorting by the arithmetic circuit. Thereafter, the CPU 21 returns the gray scale converted image to the gateway 40. The gateway 40 returns the returned image to the client computer C of the request source of the image processing request via the network N (step S15).

When the designation information of the image processing request is, for example, cutting processing of a moving image source other than the pixel sorting processing and the gray scale processing, the CPU 21 of the first computer 20 returns a replay in which the processing cannot be performed to the gateway 40. When the reply is received (step S13; No), the gateway 40 discriminate whether or not a new arithmetic circuit for executing the image processing of the image processing request can be written in the first accelerator 24 of the first computer 20 (step S16). In this discrimination, the gateway 40 discriminates whether or not a circuit configuration representing an arithmetic circuit for performing the cutting processing is stored in the storage device 23 of the first computer 20. Further, the gateway 40 discriminates whether or not an unwritten region of the first region R1 of the first accelerator 24 includes a region in which the arithmetic circuit can be written.

When the writing of the new arithmetic circuit is impossible, that is, when at least one of the results of the two discrimination is negative (step S16; No), the gateway 40 returns a notification in which processing is impossible to the client computer C of the transmission source of the image processing request of this time (step S17).

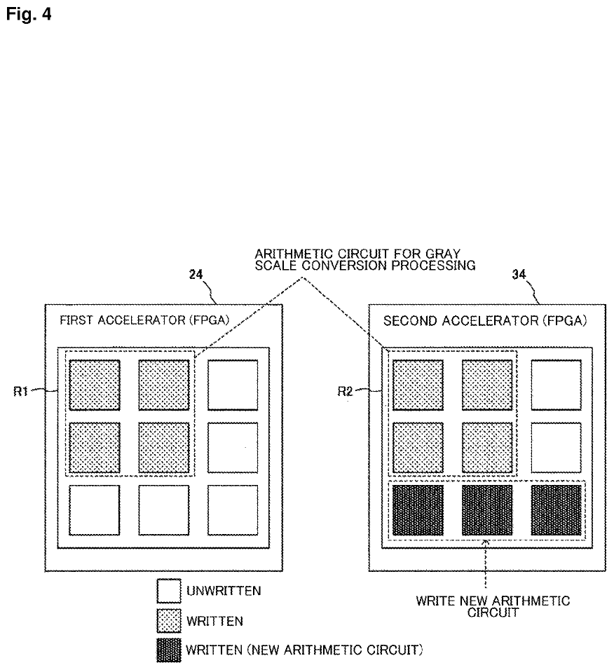

When both of the two discrimination results are affirmative (when the circuit configuration is stored in the storage device 23 and the arithmetic circuit can be written), the gateway 40 causes the second computer 30 to perform image processing of a type designated by designation information of the image processing request, that is, a writing command of an arithmetic circuit for performing the cutting processing of the moving image source (step S18). When this command is issued, the CPU 31 of the second computer 30 reads out the circuit configuration representing the arithmetic circuit of the cutting processing from the storage device 33, and writes the arithmetic circuit in this region by applying the read circuit configuration to the unwritten region of the second accelerator 34 (refer to FIG. 4). The writing position is designated by the gateway 40. Thereafter, the CPU 31 executes a predetermined program, operates as a test data generation unit for generating test data for the arithmetic circuit, inputs the test data to the arithmetic circuit, causes the arithmetic circuit to perform test operations, and confirms the normality of the arithmetic circuit. Note that the test data generation unit may be constituted by an external unit of the second computer 30, for example, the CPU in the gateway 40. When the arithmetic circuit operates normally or does not operate normally, the CPU 31 notifies the gateway 40 of the effect.

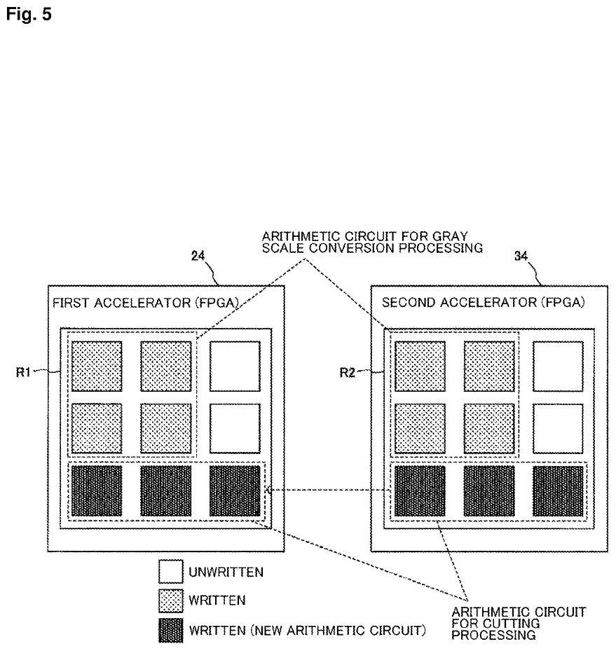

When the notification that the arithmetic circuit operates normally is given (step S19; Yes), the gateway 40 commands the first computer 20 to perform the image processing of the type designated by the designation information of the image processing request, that is, to write the arithmetic circuit for performing the cutting processing of the moving image source to the first accelerator 24 (step S20). Further, the gateway 40 transmits an image included in the image processing request and an instruction of image processing in the new arithmetic circuit to the first computer 20 (step S21). The CPU 21 of the first computer 20 applies the circuit configuration to the first accelerator 24 to write the arithmetic circuit (refer to FIG. 5) by the writing command, inputs the image to the arithmetic circuit, and acquires an image after image processing outputted by the arithmetic circuit. The CPU 21 returns the acquired image to the gateway 40. The gateway 40 returns the returned image to the client computer C of the request source of the image processing request via the network N (step S22).

When the notification that the arithmetic circuit does not operate normally is given (step S19; No), the gateway 40 returns the effect that the processing is impossible to the client computer C of the transmission source of the image processing request of this time (step S17).

When the arithmetic circuit for performing the image processing requested from the client computer C is not written in the first accelerator 24 of the first computer 20 by the series of processing as described above, this arithmetic circuit is written in the first accelerator 24. At the time of writing, first, the second computer 30 writes a new arithmetic circuit in a partial region of the second region R2 at the same position as the unwritten partial region of the first region R1. Then, the first computer 20 writes the new arithmetic circuit in the unwritten partial region of the first region R1 only when the new arithmetic circuit is normally written in the second region R2. Thus, there is a high possibility that the arithmetic circuit is normally written in the first accelerator 24, and inconvenience that the arithmetic circuit is not normally written and the first accelerator 24 does not normally operate when the arithmetic circuit is directly written in the first accelerator 24 is hardly generated.

Further, when the new arithmetic circuit is written in the second region R2, the arithmetic circuit is operated. Then, when the arithmetic circuit is normally operated, the arithmetic circuit is written in the first accelerator 24 of the first computer 20 on the assumption that the arithmetic circuit is normally written in the second region R2. Thus, for example, a user A requests pixel sorting processing and gray scale conversion processing from the computing system 10, and during execution of the pixel sorting processing and gray scale processing, even when a user B requests the cutting processing of the moving image source, the arithmetic circuit is suitably written. That is, even when the first accelerator 24 is in operation or the CPU 21 of the first computer 20 executes other processing, since the operation for testing the new arithmetic circuit is performed by the second accelerator 34 of the second computer 30, the influence on the first accelerator 24 and the influence on the first computer 20 (influence on traffic or the like) due to the operation of the test can be suppressed. Therefore, the new arithmetic circuit can be introduced into the first accelerator 24 while securing the reliability of the first computer 20. Thus, the conventional inconvenience such as the deterioration of the reliability of the first computer 20 at the time of introducing the new arithmetic circuit can be eliminated. Note that when the operation for the test is not performed and the arithmetic circuit can be written in the second accelerator 34 without abnormality, it may be determined that the new arithmetic circuit is written normally in the second region R2.

In the above embodiment, as shown in FIG. 5, the arithmetic circuit written in the first region R1 of the first accelerator 24 and the arithmetic circuit written in the second region R2 of the second accelerator 34 are made the same including the writing position, a written part and an unwritten part in both the regions R1 and R2 may be set at the same position, and a dummy circuit, for example, may be written in the second region R2. However, as shown in FIG. 5, it is preferable that the arithmetic circuit written in the first region R1 of the first accelerator 24 and the arithmetic circuit written in the second region R2 of the second accelerator 34 are made the same including the writing position. Thus, in the second computer 30, the already written arithmetic circuit and the newly written arithmetic circuit can be caused to perform the test operations in parallel. Then, in the second computer 30, the newly written arithmetic circuit and the other arithmetic circuits are caused to perform the test operations in parallel, and the new arithmetic circuit may be written in the first accelerator 24 only when there is no abnormality in each test operation. Thus, the new arithmetic circuit can be written in the first accelerator 24 without adversely affecting the existing arithmetic circuit.

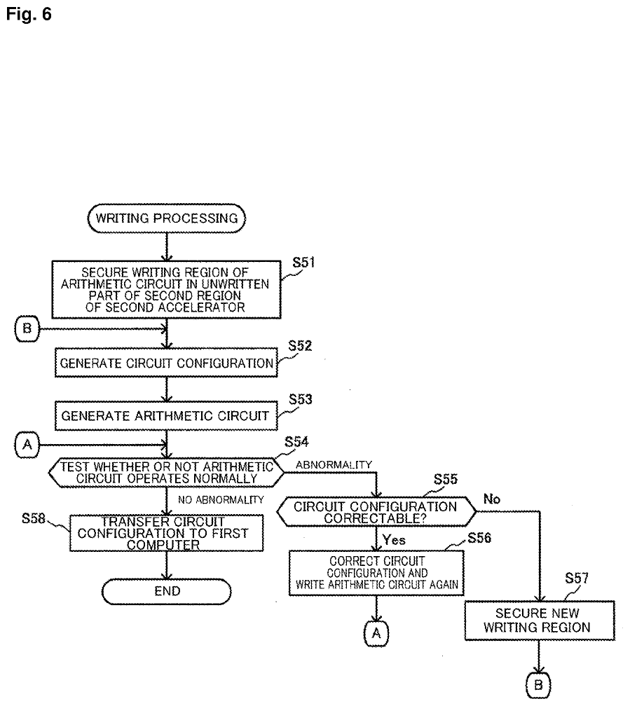

In the case where the reply indicates that the image processing is impossible in the step S13 (step S13; No) or the like, when the gateway 40 notifies the client computer C of the effect, the client computer C may supply a writing instruction to newly generate and write the circuit configuration of the arithmetic circuit for performing the image processing to the gateway 40 via the network N. The instruction is supplied to the gateway 40 together with a program for generating a circuit configuration of the arithmetic circuit. The program may include a hardware description language or the like that is a source of the circuit configuration. The gateway 40 receiving the writing instruction executes the writing processing shown in FIG. 6 together with the second computer 30.

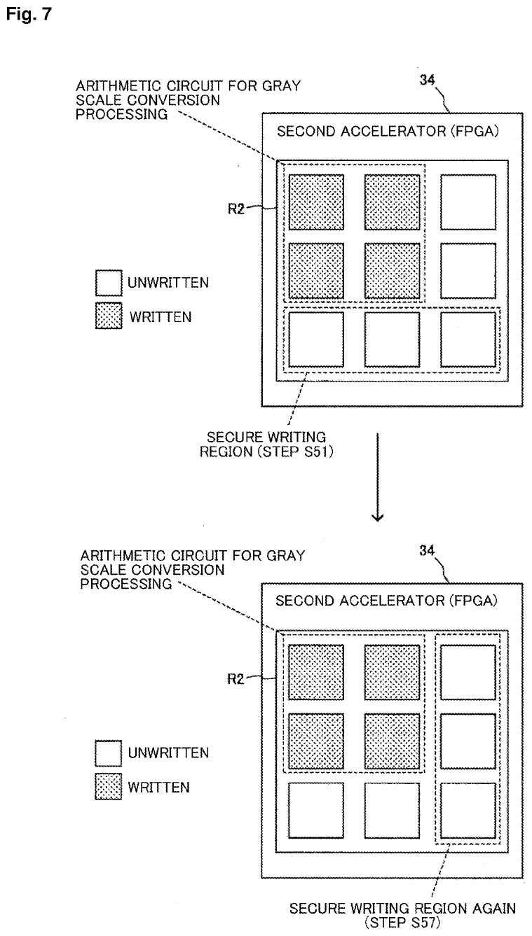

In the writing processing shown in FIG. 6, the gateway 40 first secures a writing region for writing the new arithmetic circuit in the unwritten part of the second region R2 of the second accelerator 34 of the second computer 30 (step S51). By this securing, another circuit is prevented from being written in the writing region. The size of the writing region is specified from the scale of the program (hardware description language or the like) supplied together with the writing instruction. Here, it is assumed that a part indicated by a dotted line in FIG. 7 is secured as the writing region. The wring region is located at the same position as an unwritten part of the first region R1 of the first accelerator 24 of the first computer 20. Note that in order to avoid performance deterioration due to band congestion, the gateway 40 may secure an input/output terminal located at the same position as an unused input/output terminal of the first accelerator 24 as an input/output terminal of the writing region to be secured. When the writing region cannot be secured, the gateway 40 returns the effect to the client computer C.

Thereafter, the gateway 40 supplies the program supplied together with the writing instruction to the second computer 30, and the CPU 31 of the second computer 30 executes the supplied program, and generates a circuit configuration for configuring the arithmetic circuit in the writing region secured in the step S51 (step S52). The generation of the circuit configuration appropriately includes processing such as logic synthesis of hardware description language and arrangement wiring included in the program. Thereafter, the CPU 31 applies the generated circuit configuration to the currently secured writing region, and writes the arithmetic circuit in the region (step S53, refer to FIG. 4).

Thereafter, the CPU 31 of the second computer 30 operates the arithmetic circuit written in the step S53 and tests whether or not the arithmetic circuit operates normally (step S54). The CPU 31 performs a test as to whether the test patterns (test data) normally operate by inputting the test patterns to the arithmetic circuit and operating the test patterns. In the test, when the occurrence probability of the frame loss is higher than a predetermined reference or when an operation different from a normal operation scenario is performed, for example, when the contents of a response to a prescribed request inputted to the arithmetic circuit are different, it is determined that the arithmetic circuit does not normally operate. Note that it is preferable that the reference for determining whether or not it operates normally is predetermined. Thus, the effective determination can be obtained. The test patterns may be generated by the CPU 31 of the second computer 30 operating as a test pattern generation device for generating the test patterns, or may be acquired from a test pattern generation device connected to the second computer 30. The test patterns may be supplied to the second computer 30 via the gateway 40 together with the writing instruction. An FPGA may be used for generating the test patterns. Thus, a high-load test patterns is easily generated.

When there is abnormality in the operation of the arithmetic circuit, the CPU 31 discriminates whether or not the arithmetic circuit can be corrected (step S55). When the correction is possible (step S55; Yes), the CPU 31 corrects the circuit configuration, applies the corrected circuit configuration to the second region R2, and writes the corrected arithmetic circuit in the same position of the second region R2 (step S56). When the arithmetic circuit can be corrected, the CPU 31 may transmit the effect that the correction of the arithmetic circuit is necessary to the client computer C via the gateway 40 or the like. The correction of the circuit configuration may be correction of the original program that generates the circuit configuration and generation of the circuit configuration based on the corrected program. The correction of the circuit configuration may be correction of the hardware description language and logic synthesis and arrangement wiring based on the corrected hardware description language.

When the correction of the arithmetic circuit is difficult (step S55; No), the CPU 31 secures the other unwritten part in the second region as the new writing region (step S57, for example, refer to FIG. 7), and performs processing after the step S52.

When there is no abnormality in the operation of the arithmetic circuit (step S54; Yes), the CPU 31 transfers the circuit configuration of the arithmetic circuit to the first computer 20 via the gateway 40 together with the writing position of the arithmetic circuit (step S58). The first computer 20 applies the transferred circuit configuration to the first accelerator 24, and writes the arithmetic circuit having no abnormality in the writing position.

By the series of processing, the arithmetic circuit originally written in the first accelerator 24 of the first computer 20 is once written in the second accelerator 34 of the second computer 30, and after operation confirmation (here, test by the test patterns) of the arithmetic circuit is performed, this arithmetic circuit is written in the first accelerator 24. Therefore, even when processing by the first accelerator 24 of the first computer 20 or other processing for executing a program by the CPU 21 of the first computer 20 is being already executed at the start of writing processing of the arithmetic circuit, the writing of the arithmetic circuit can be suppressed from affecting the processing of the first accelerator 24 or the processing of the CPU 21 of the first computer 20, and a highly reliable computing system 10 is realized. Further, since the logical synthesis or the like is executed on the second computer 30 side in the above-described manner, it is not necessary to perform the logical synthesis or the like by the first computer 20, and the processing load of the first computer 20 is reduced.

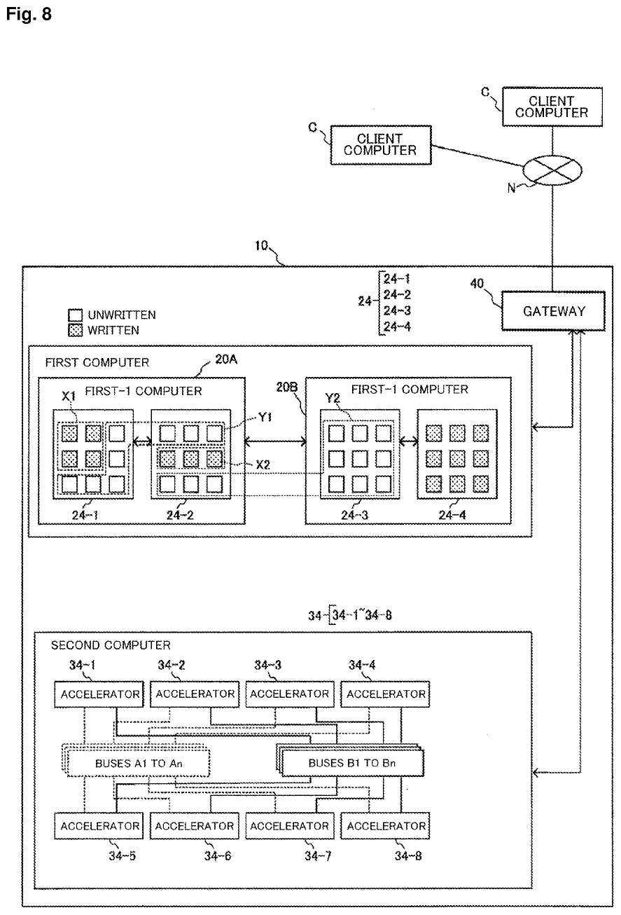

Another modification example of the computing system 10 will be described with reference to FIG. 8. Note that in FIG. 8, attention is paid to the accelerator, and the CPU and the like are omitted.

The first computer 20 includes a first-1 computer 20A and a first-2 computer 20B. The first-1 computer 20A includes a plurality of accelerators 24-1 and 24-2. The first-2 computer 20B includes a plurality of accelerators 24-3 and 24-4. The first-1 computer 20A and the first-2 computer 20B are connected by a network such as a LAN and the Internet not shown in the figure, and the accelerators 24-1 to 24-4 become one first accelerator 24 as a whole.

The second computer 30 includes N (eight in this case) accelerators 34-1 to 34-N. The accelerators 34-1 to 34-N are interconnected by buses A1 to An (n=N*(N−1)/2). Further, the accelerators 34-1 to 34-N are interconnected by buses B1 to Bn (n=N*(N−1)/2) separated from the buses A1 to An. The buses A1 to An connect the accelerators 34-1 to 34-N so that the accelerators 34-1 to 34-N constitute a chain. The buses B1 to Bn connect the accelerators 34-1 to 34-N so as to constitute a starting point (input) and an end point (output) of the chain. In order to realize these configurations, a part of the buses A1 to An and the buses B1 to Bn may be cut off so as not to be properly used. By such interconnection, the accelerators 34-1 to 34-N become one second accelerator 34 as a whole, and simulate a path of a chain to be described later.

The first accelerator 24 consisting of accelerators 24-1 to 24-4 and the second accelerator 34 consisting of accelerators 34-1 to 34-N can be regarded as having a reconfigurable first region and a second region of the same circuit arrangement as a whole.

An operation of the computing system 10 of the modification example will be described next. In this case, it is assumed that the arithmetic circuits X1 and X2 are written in two accelerators 24-1 and 24-2 of the first-1 computer 20A by the user A. The arithmetic circuit X1 of the accelerator 24-1 performs preprocessing on an image to be processed. The arithmetic circuit X2 infers image contents on the basis of the image preprocessed by the arithmetic circuit X1. The arithmetic circuits X1 and X2 have a chain configuration. In this state, it is assumed that only processing by the arithmetic circuits X1 and X2 is executed, and the first-1 computer 20A is in an operating state.

In this case, it is assumed that new image processing is requested from the client computer C operated by the user B to the gateway 40. When the requested image processing can be performed by the first computer 20, the gateway 40 sets the communication destination of the client computer C as the first computer 20, but the present image processing cannot be performed by the first computer 20 because it is new processing. At this time, the gateway 40 switches the communication destination of the client computer C to the second computer 30. At this time, the client computer C of the user B supplies a program for generating a circuit configuration representing an arithmetic circuit of image processing requested by the user B to the second computer 30.

It is assumed that the image processing requested by the user B is processing for performing image inference processing after performing image preprocessing by chain processing similar to that of the user A. The CPU 31 of the second computer 30 discriminates that the processing amount of the preprocessing is smaller than the processing amount of the inference from the contents of the program from the client computer C. From the estimation, in an unwritten part of the first computer 20, for example, a writing region Y1 in FIG. 8 is defined as a writing region in which an arithmetic circuit for performing image preprocessing is written, an unwritten region Y2 is temporarily set as a writing region in which an arithmetic circuit for performing inference processing after preprocessing is written. Each written part and unwritten part of the first accelerator 24 and the second accelerator 34 are shared. The CPU 31 writes the arithmetic circuit of the user B in the regions of the second accelerator 34 corresponding to the unwritten regions Y1 and Y2 on the basis of the temporary setting result. After writing, normal operation (including long-term stable operation) of the arithmetic circuit is confirmed. After the sufficient inspection, the arithmetic circuit is written in the writing regions Y1 and Y2, and the normal operation of the second accelerator 34 is enabled. Note that since the arithmetic circuit of the user B and the arithmetic circuit of the user A are written in the second accelerator 34, for example, the operation side of the system transfers data actually used by the first computer 20 to the second computer 30 side and inputs the data to the second accelerator 34, by writing the new arithmetic circuit on the user B side, it is confirmed whether or not the operation of the arithmetic circuit on the user A side already written is affected.

Here, the buses A1 to An are buses constituted of one optical transmission line and a plurality of optical filters as a whole. Similarly, the buses B1 to Bn are preferably constituted of one optical transmission line and a plurality of optical filters. In the bus, optical wavelength multiplex communication using a plurality of different optical wavelengths is performed. In this way, the plurality of accelerators is preferably connected to one transmission line so as to be able to communicate with each other by light of different wavelengths in each set of accelerators performing communication. According to this configuration, since it is not necessary to give an ID for distribution such as an electric switch to various buses in the chain between connections, there is an advantage that a delay can be reduced.

A hardware configuration of the computing system 10 is arbitrary. For example, at least two of the first computer 20, the second computer 30, and the gateway 40 may be implemented by the same computer. For example, the CPU 21 of the first computer 20 may function as the gateway 40 to execute processing of the gateway 40. The processing performed by the first computer 20 and the second computer 30 is not limited to the image processing, but may be other processing. In addition to or in place of the second accelerator 34, the first accelerator 24 may also include a plurality of accelerators interconnected in the same manner as the second accelerator 34 shown in FIG. 8. Thus, the path of the chain may be simulated by the first accelerator 24.

### Scope of Embodiments of the Present Invention

The present invention has been described thus far with reference to the embodiments and the modification example, but the present invention is not limited to the above embodiments and the modification example. For example, the present invention includes various changes to the above embodiments and modification example that can be understood by those skilled in the art within the scope of the technical idea of the present invention. The structures described in the above-mentioned embodiments and the modification example can be appropriately combined within a range without contradiction.

### REFERENCE SIGNS LIST

10 Computing system
20, 20A, 20B First computer
22 Main memory
24 First accelerator
24-1 to 4 Accelerator
30 Second computer
34 Second accelerator
34-1 to N Accelerator
40 Gateway
A1 to An Bus
B1 to Bn Bus
C Client computer
N Network
R1 First region
R2 Second region
X1, X2 Arithmetic circuit
Y1, Y2 Region

1-7. (canceled)

8. A computing system comprising:
a first computer configured to write an arithmetic circuit in a reconfigurable first region of a first accelerator; and
a second computer configured to write the arithmetic circuit in a reconfigurable second region of a second accelerator different from the first accelerator, the second region of the second accelerator having a same circuit arrangement as the first region of the first accelerator, wherein
the second computer is configured to write a new arithmetic circuit in a partial region of the second region at the same position as an unwritten partial region of the first region when the first computer writes the new arithmetic circuit in the first region, and
the first computer is configured to not write the new arithmetic circuit to the first region when the new arithmetic circuit is not normally written in the second region, and write the new arithmetic circuit to the unwritten partial region of the first region when the new arithmetic circuit is normally written in the second region.

9. The computing system according to claim 8, wherein the second computer is configured to:
operate the new arithmetic circuit when writing the new arithmetic circuit; and
determine whether the new arithmetic circuit is normally written based on whether the arithmetic circuit operates normally.

10. The computing system according to claim 9, further comprising:
a generation circuit configured to generate test data to be inputted to the new arithmetic circuit when the second computer operates the new arithmetic circuit.

11. The computing system according to claim 8, wherein:
the second computer is configured to cause the arithmetic circuit and the new arithmetic circuit to perform test operations in parallel when the arithmetic circuit having the same content has been written at the same position of the first region and the second region; and
the first computer is configured to write the new arithmetic circuit into the unwritten partial region of the first accelerator when the arithmetic circuit and the new arithmetic circuit perform normal test operations.

12. The computing system according to claim 8, further comprising a third computer configured to:
control writing of the arithmetic circuit into the first region by the first computer and writing of the arithmetic circuit into the second region by the second computer, wherein
cause the second computer to write the new arithmetic circuit; and
cause the first computer to write the new arithmetic circuit when the new arithmetic circuit is normally written in the second region.

13. The computing system according to claim 8, wherein
at least one of the first accelerator or the second accelerator is configured to include a plurality of FPGA accelerators that constitutes the first region or the second region and is interconnected.

14. The computing system according to claim 13, wherein
a plurality of accelerators is connected to one transmission line so that the plurality of FPGA accelerators communicates with each other by light of different wavelengths in each set of the plurality of FPGA accelerators performing communication.

15. A method of operating a computing system comprising:
writing, by a first computer, write an arithmetic circuit in a reconfigurable first region of a first accelerator; and
writing, by a second computer, the arithmetic circuit in a reconfigurable second region of a second accelerator different from the first accelerator, the second region of the second accelerator having a same circuit arrangement as the first region of the first accelerator, wherein
the second computer writes a new arithmetic circuit in a partial region of the second region at the same position as an unwritten partial region of the first region when the first computer writes the new arithmetic circuit in the first region, and
the first computer does not write the new arithmetic circuit to the first region when the new arithmetic circuit is not normally written in the second region, and writes the new arithmetic circuit to the unwritten partial region of the first region when the new arithmetic circuit is normally written in the second region.

16. The method according to claim 15, wherein
operating, by the second computer, the new arithmetic circuit; and
determining whether the new arithmetic circuit is normally written based on whether the arithmetic circuit operates normally.

17. The method according to claim 15, further comprising:
generating test data to be inputted to the new arithmetic circuit when the second computer operates the new arithmetic circuit.

18. The method according to claim 15, wherein:
causing, by the second computer, the arithmetic circuit and the new arithmetic circuit to perform test operations in parallel when the arithmetic circuit having the same content has been written at the same position of the first region and the second region; and
writing, by the first computer, the new arithmetic circuit into the unwritten partial region of the first accelerator when the arithmetic circuit and the new arithmetic circuit perform normal test operations.

19. The method according to claim 15, further comprising:
controlling, by a third computer, writing of the arithmetic circuit into the first region by the first computer and writing of the arithmetic circuit into the second region by the second computer, wherein
causing, by the third computer, the second computer to write the new arithmetic circuit; and
Causing, by the third computer, the first computer to write the new arithmetic circuit when the new arithmetic circuit is normally written in the second region.

20. The method according to claim 15, wherein
at least one of the first accelerator or the second accelerator is configured to include a plurality of FPGA accelerators that constitutes the first region or the second region and is interconnected.

21. The method according to claim 20, wherein
a plurality of accelerators is connected to one transmission line so that the plurality of FPGA accelerators communicates with each other by light of different wavelengths in each set of the plurality of FPGA accelerators performing communication.
